(19) United States
(12) Patent Application Publication
(10) Pub. No.: US 2014/0143720 A1
(43) Pub. Date: May 22, 2014

(54) ITEM RECOMMENDATIONS

(71) Applicant: BFF Biz, LLC, Kirkland, WA (US)

(72) Inventors: Elizabeth S. Dimarco, Redmond, WA (US); Kathleen L. Weber, Kirkland, WA (US)

(73) Assignee: BFF Biz, LLC, Kirkland, WA (US)

(21) Appl. No.: 14/081,213

(22) Filed: Nov. 15, 2013

Related U.S. Application Data
(60) Provisional application No. 61/727,597, filed on Nov. 16, 2012.
(60) Provisional application No. 61/886,041, filed on Oct. 2, 2013.

(51) Int. Cl. G06F 3/0482

(52) U.S. Cl. CPC G06F 3/0482
USPC 715/810

(57) ABSTRACT

Systems and methods are disclosed that facilitate categorization of preferences for items, and generation of recommendation based on such preferences. Specifically, users are enabled to identify elements of items, such as written works, that they prefer. Each element can generally refer to a specific aspect or portion of the written work, as opposed to describing the work as a whole. Users are further enabled to select descriptors for each element, which describe their preferences for the element. Thereafter, natural language recommendations can be generated from the selected elements and descriptors, and transmitted to additional other users or prospective users. The selected element and descriptor pairs may also be used to categorize the work, and to automatically generate recommendations for the work.

### CROSS-REFERENCE TO RELATED APPLICATIONS

This application claims the benefit of U.S. Provisional Patent Application No. 61/727,597, entitled ITEM RECOMMENDATIONS, and filed on Nov. 16, 2012, and of U.S. Provisional Patent Application No. 61/886,041, entitled ITEM RECOMMENDATIONS, and filed on Oct. 2, 2013, the entireties of which are hereby incorporated by reference.

### BACKGROUND

Web sites and other types of interactive systems commonly include recommendation systems for providing personalized recommendations of items stored or represented in a data repository. The recommendations are typically generated based on monitored user activities or behaviors, such as item purchases, item viewing events, item rentals, and/or other types of item selection actions. In some systems, the recommendations are additionally or alternatively based on users' explicit ratings of items.

Traditional collaborative recommendations processes operate by attempting to match users to other users having similar behaviors or interests. For example, once Users A and B have been matched, items favorably sampled by User A but not yet sampled by User B may be recommended to User B. In addition, some recommendation systems seek to identify items having content (e.g., text) that is similar to the content of items selected by the user.

However, research shows that the top way people choose the books they read is through word-of-mouth. Despite the proliferation of social media tools, online venues such as review sites and data-mining algorithmic recommendations are not widely trusted by readers because of the perception that they are neither personal nor accurate. In addition, the methods used by publishers to select books for publishing may not be based on empirical data other than number of sales of previous works by an author or, in the case of a new author, number of sales of a similar book.

### BRIEF DESCRIPTION OF THE DRAWINGS

FIG. 1 is a block diagram depicting an illustrative operating environment in which an electronic item cataloging service enables users to catalog items of interest to the user, to specify preferences for items based on item elements, and to generate recommendations for other users based on item preferences.

FIG. 2A depicts an illustrative interaction of a first user with the electronic item cataloging service of FIG. 1, including the generation of an item recommendation for a second user.

FIG. 2B depicts an illustrative interaction of the electronic item cataloging service of FIG. 1 with the second user, including generation and transmission of an item recommendation to the second user based on preferences of the first user.

FIG. 3A is an illustrative user interface enabling a user to define preferences for an item based on selection of elements of the item, which may be used to generate a recommendation for the item.

FIG. 3B is an illustrative user interface enabling a user to further define preferences for an item based on selection of element descriptors, which may be used to generate a recommendation for the item.

### DETAILED DESCRIPTION

Generally described, the present disclosure relate to managing recommendations for items, such as books, audiobooks or movies. More specifically, aspects of the present disclosure enable users to describe their preferences for items based on individual elements of the item. Past implementations of recommendation services have frequently based recommendations on qualitative aspects of an item as whole. For example, recommendations of books are frequently based on a genre or author of the book, or on critical reviews of the work. However, non-systematized, non-automated recommendations (e.g., word-of-mouth recommendations) are often not based on such qualitative aspects of a book as whole. Rather, it is common for users to identify with or relate to individual elements of an item, such as individual characters, scenes, or plot points. Aspects of the present disclosure therefore enable users to describe their preferences for items with respect to such individual elements, and to generate recommendations based on these preferences. In addition, aspects of the present disclosure enable users to receive feedback based on their generated recommendations. Still further, aspects of the present disclosure enable the generation of recommendations to a user based on their previously described preferences.

Generally described, elements represent individual portions or aspects of an item, and may generally be distinguished from descriptions of an item as a whole (e.g., genre, length, critical reviews, etc.). In one embodiment, descriptors are nouns. Examples of elements include, but are not limited to, an item's anecdotes, graphics, ideas, time period, tone, or depth. Additional examples of elements are provided below. By selection of elements, users are enabled to identify specific elements of an item that they prefer.

In addition, the present disclosure enables a user to describe their preferences for individual elements in further detail, by utilizing descriptors. Descriptors may generally correspond to words describing a specific element. In one embodiment, descriptors are adjectives. Examples of descriptors include, but are not limited to, “accessible,” “ironic,” “profound,” “raw,” “thoughtful” and “wondrous.” Additional examples of descriptors are provided below. By use of descriptors, users are enabled to specifically describe the individual elements of an item that cause them to prefer (e.g., “love”) the item.

In addition, users may be enabled to generate recommendations for items based on selected elements or element-descriptor pairs. For example, a first user may recommend an item to a second user based on the recommending user's love of the items “thoughtful” (an illustrative descriptor) “ideas” (an illustrative element). Accordingly, a receiving user is provided with specific reasons as to why the item has been recommended, at a level of detail beyond existing recommendation systems. In some embodiments, a receiving user may also be enabled to specify preferences for an item (e.g., as expressed by elements or element-descriptor pairs). These preferences of a receiving user may, in some instances, be utilized to provide feedback regarding a recommendation to a recommending user. In other embodiments, a receiving user may be enabled to directly rate a recommendation.

Still further, user selection of elements and element-descriptor pairs enables creation of new item categories based on these elements. Specifically, aspects of the present disclosure enable an item cataloging service to maintain a listing of elements and element-descriptor pairs associated with an item. These elements and element-descriptor pairs may enable users to more accurately locate previously undiscovered works by browsing or searching for items based on desired elements or element-descriptor pairs. Further, these elements and element-descriptor pairs may enable publishers, authors, or other item creators to receive more detailed feedback regarding user's preferences for an item. For example, a publisher may be notified that many users love an items “plot,” and believe the plot is “resonant.” Publishers may therefore gain knowledge regarding user's preferences for an item at an unprecedented level of detail.

Moreover, aspects of the present disclosure enable an item cataloging service to provide recommendations to users based on a comparison between the user's element preferences (e.g., a preference for “plot” or “character” elements) and items preferred by other users for these elements (e.g., books with preferred “plot” or “character” elements). Accordingly, user selection of elements and element-descriptor pairs enable recommendations to be automatically generated by an item cataloging service as described herein.

While examples may be described herein with reference to individual types of items (e.g., books), aspects of the present disclosure may be applied to any type of item. For example, the services described herein may be utilized to categorize or describe user preferences for movies, music, software, tangible or non-tangible goods (e.g., wines, vehicles, vacations), or any other product or service (e.g., presentations, seminars, etc.). Further, aspects of the present disclosure may be utilized to generate or facilitate recommendations for such items based on user preferences.

The foregoing aspects and many of the attendant advantages will become more readily appreciated as the same become better understood by reference to the following description of one illustrative embodiment, when taken in conjunction with the accompanying drawings depicting the illustrative embodiment.

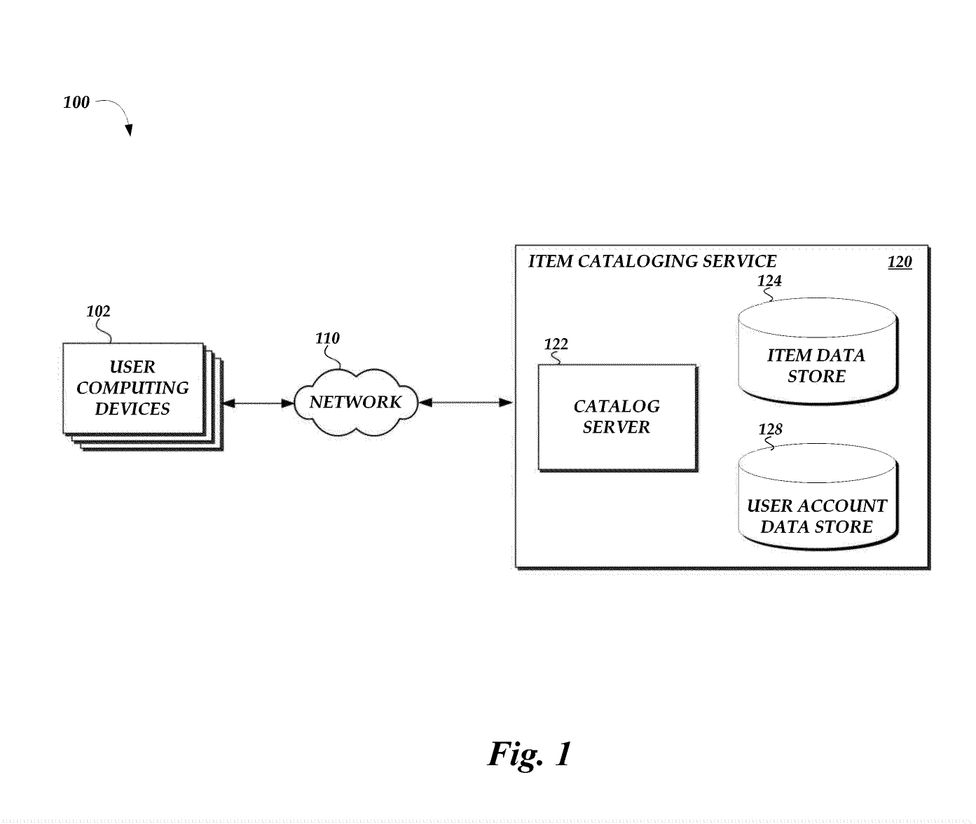

Turning to FIG. 1, a schematic block diagram is shown depicting an illustrative operating environment 100 in which a user computing device 102 may interact with an item cataloging service 110 to provide information regarding preferences for items, view or track item preferences, generate recommendations based on item preferences, and receive recommendations from other users. As illustrated in FIG. 1, the operating environment 100 includes one or more user computing devices 102 in communication with an electronic item cataloging service 120 via a network 110.

User computing devices 102 may include any number or combination of computing devices, including laptop or tablet computers, personal computers, servers, personal digital assistants (PDAs), hybrid PDA/mobile phones, mobile phones, electronic book readers, set-top boxes, cameras, digital media players, and the like. Those skilled in the art will appreciate that the network 110 may be any wired network, wireless network or combination thereof. In addition, the network 110 may be a personal area network, local area network, wide area network, cable network, satellite network, cellular telephone network, or combination thereof. In the illustrated embodiment, the network 110 is the Internet. Protocols and components for communicating via the Internet or any of the other aforementioned types of communication networks are well known to those skilled in the art of computer communications and thus, need not be described in more detail herein.

Accordingly, a user, using his or her computing device 102, may communicate with the item cataloging service 120 regarding items preferred by the user. By way of non-limiting example, items may correspond to books (including electronic books, audio books, etc.), audio recordings (e.g., music, audio shows, etc.), video recordings (e.g., movies, documentaries, etc.), games or other multimedia. In one embodiment, users may register with the item cataloging service 120 prior to utilizing the service. For example, a user may provide registration information, such as the user's name, email, gender, year of birth, zip code, or affiliation (e.g., book seller, author, book club member, publishing professional and/or librarian). In some embodiments, users may be enabled to register with the system by use of an existing account, such as an account on a social networking system (e.g., FACEBOOK™, TWITTER™, etc.). Techniques for interacting with social networking systems (e.g., to register with a third party service) are well known within the art, and therefore will not be described in detail herein.

In one embodiment, a user may communicate with the item cataloging service 120 in order to search for and locate an item of interest. The item cataloging service 120 maintains an item data store 124 including information regarding items cataloged by the item cataloging service 120. In one embodiment, the item data store 124 may include the title, author, and publication date of a book, as well as additional information regarding the book (e.g., cover page, preferences of users for the book, etc.). In another embodiment, all or a portion of information regarding items cataloged by the item cataloging service 120 may be maintained within an external data store (not shown in FIG. 1), such as a data store associated with an electronic catalog service offering the item for sale. Accordingly, by utilizing functionality of the item cataloging service 120, a user may search for information regarding a specific item within the item cataloging service 120. Thereafter, the user may track or tag the item (e.g., by adding the item to a personal “shelf”), and thereby maintain the item within a personalized catalog of the user. In addition, the user may input preferences regarding elements of the item, and use such preferences to generate recommendations for other users. Furthermore, the user may receive recommendations from the item cataloging service 120 based on previously input preferences.

The item cataloging service 120 is illustrated in FIG. 1 as operating in a distributed computing environment including several computer systems that are interconnected using one or more networks. More specifically, the item cataloging service 120 may include a catalog server 122, an item data store 124, and a user account data store 128 discussed in greater detail below. However, it may be appreciated by those skilled in the art that the item cataloging service 120 may have fewer or greater components than are illustrated in FIG. 1. In addition, the item cataloging service 120 could include various web services and/or peer-to-peer network configurations. Thus, the depiction of item cataloging service 120 in FIG. 1 should be taken as illustrative and not limiting to the present disclosure.

Any one or more of the catalog server 122, the item data store 124 and the user account data store 128 may be embodied in a plurality of components, each executing an instance of the respective catalog server 122, item data store 124 and user account data store 128. A server or other computing component implementing any one of the catalog server 122, the item data store 124 and the user account data store 128 may include a network interface, memory, processing unit, and computer readable medium drive, all of which may communicate which each other may way of a communication bus. The network interface may provide connectivity over the network 110 and/or other networks or computer systems. The processing unit may communicate to and from memory containing program instructions that the processing unit executes in order to operate the respective catalog server 122, item data store 124 and user account data store 128. The memory may generally include RAM, ROM, other persistent and auxiliary memory, and/or any non-transitory computer-readable media.

With further reference to FIG. 1, illustrative components of the item cataloging service 120 will now be discussed. Specifically, the item cataloging service 120 may include a catalog server 122 configured to interact with a user computing device 102. The catalog server 122 may enable a user to search for and locate items of interest (e.g., as represented within the item data store 124).

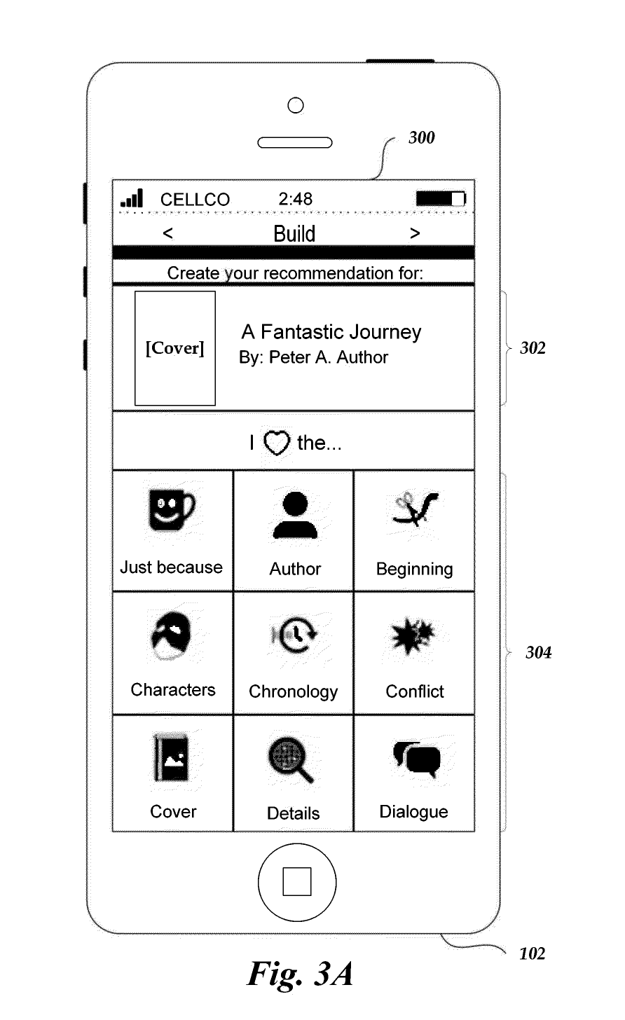

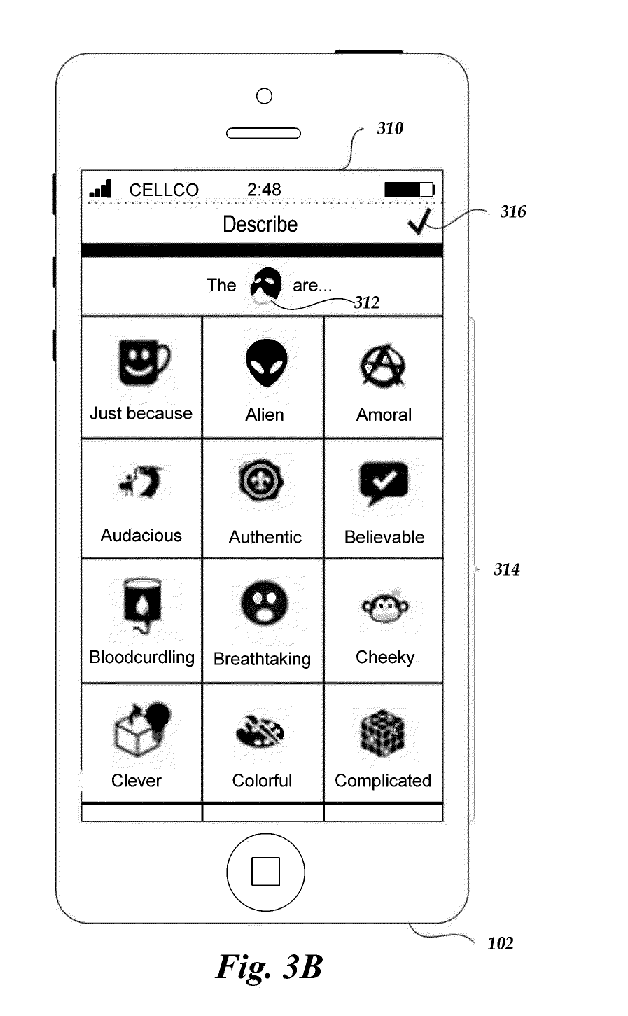

In addition, the catalog server 122 may enable a user to specify preferences for elements of an item of interest. Generally described, elements can correspond to a specific portion, aspect or characteristic of a book, and represent one basis on which a recommendation can be made. Elements may generally be distinguished from descriptions of an item as a whole (e.g., genre, length, critical reviews, etc.). In one instance, elements may correspond to nouns. As will be described below, these nouns may be utilized by item cataloging service 120 to generate natural-language recommendations for an item. Examples of aspects or elements are shown within table 1, below. One skilled in the art will appreciate the examples given within table 1 are illustrative in nature, and not intended to be exhaustive. Further, one illustrative interface for enabling user specification of elements will be described with respect to FIG. 3A, below.

TABLE 1
Elements

| | | |
|---|---|---|
| Anecdotes | Author | Beginning |
| Characters | Chronology | Conclusions |
| Conflict | Cover | Depth |
| Details | Dialogue | Ending |
| Examples | Expertise | Flow |
| Format | Graphics | Hero |
| Heroine | History | Humor |
| Ideas | Illustrations | Insights |
| Language | Mystery | Pacing |
| Philosophy | Photos | Premise |
| Relationships | Romance | Setting |
| Sidekick | Solutions | Subject Matter |
| Subject Range | Teachings | Themes |
| Thesis | Time Period | Title |
| Tone | Typography | Vignettes |
| Villain | Voice | World-building |

The catalog server 122 may further enable a user to specify descriptors for a selected element. Descriptors may generally act to describe a selected element, rather than an item as whole. In one instance, descriptors correspond to adjectives. Some examples of descriptors are shown within table 2 below. As noted above, the examples provided within table 2 are illustrative in nature, and not intended to be exhaustive. Further, one example of a user interface for enabling user specification of descriptors will be described with respect to FIG. 3B, below.

TABLE 2
Descriptors

| | | |
|---|---|---|
| Accessible | Actionable | Alien |
| Amoral | Audacious | Authentic |
| Balanced | Believable | Bloodcurdling |
| Breathtaking | Cheeky | Clear |
| Clever | Colorful | Complex |
| Complicated | Concrete | Creative |
| Creepy | Current | Dark |
| Dreamy | Elusive | Enchanting |
| Ethereal | Expansive | Factual |
| Familiar | Fluid | Forbidden |
| Foreign | Fresh | Funny |
| Grounded | Hair-Raising | Heart-Breaking |
| Hilarious | Historical | Honest |
| Hopeful | Innovative | Inspirational |
| Inspiring | Instructive | Intriguing |
| Inviting | Ironic | Irresistible |
| Jaded | Joyful | Juicy |
| Lyrical | Magical | Meaningful |
| Meaty | Moral | Motivational |
| Multifaceted | Mystical | New |
| Organic | Original | Page-Turning |
| Passionate | Personal | Persuasive |
| Plausible | Poetic | Poignant |
| Powerful | Practical | Profound |
| Provocative | Quotable | Raw |
| Relevant | Resonant | Romantic |
| Sassy | Scary | Scintillating |
| Seductive | Sensual | Serious |
| Sexy | Simple | Sinister |
| Smart | Snarky | Spiritual |
| Spooky | Step-By-Step | Supernatural |
| Surprising | Suspenseful | Sweet |
| Technical | Therapeutic | Thoughtful |
| Thrilling | Timely | Transferable |
| Transformational | Truthful | Twisted |
| Understandable | Useful | Weighty |
| Wise | Witty | Wondrous |

After receiving selection of one or more elements, and optionally one or more descriptors for each element, the web server 112 may store the elements and associated descriptors as preferences of the user. Illustratively, these preferences may be stored within the user account data store 128. For example, if a user describes a preference for the illustrative fictitious novel “A Fantastic Journey” due to the novel's “thrilling” (a descriptor) “pacing” (an element), the web server 112 may store such a preference within the user account data store 128. In some embodiments such stored preferences may thereafter be utilized to generate recommendations for a user. For example, where a user has indicated a preference for a specific element and descriptor combination, the item cataloging service 120 may be configured to locate additional items sharing the specific element and descriptor combination, and to provide a recommendation for such additional items to the user.

In addition, the catalog server 122 may utilize a user's preferences to modify or update item information within the item data store 124. For example, where a user has described a preference for the novel “A Fantastic Journey” due to the novel's “thrilling” (a descriptor) “pacing” (an element), the catalog server 122 may modify information within the data store 124 to reflect that “A Fantastic Journey” includes “thrilling pacing.” This information may thereafter be used to provide recommendations to other users that have expressed a preference for items with “thrilling pacing.”

Still further, the catalog server 122 may enable a user to request generation of a recommendation to another user based on an expressed preference. In one embodiment, such a recommendation may be generated based on a recommending user's preferences (e.g., the recommending user's preference for the “thrilling pacing” of a novel). In another embodiment, such a recommendation may be generated based on a recommending user's expectation regarding preferences of a receiving user (e.g., the recommending user's expectation that a receiving user will love a novel's “quotable characters”).

Thereafter, the catalog server 122 may utilize a user's specified preference to generate a natural language for an item. For example, the catalog server 122 may utilize a set of natural language templates to generate sentences describing an item or a user's preference for an item. Each template may correspond to an element and/or an element/descriptor pair. Examples of templates corresponding to an element are show within table 3 below, while examples of templates corresponding to element/descriptor pairs are shown within table 4. As noted above, the examples provided within tables 3 and 4 are illustrative in nature, and not intended to be exhaustive.

TABLE 3
Natural-language sentences based on an element

I'm impressed by this book's <element>.
The author creates a(n) <element> that really stands out.
The <element> is notable.
<Book Title>'s <element> held me captive.
The <element> captivated my imagination.
The <Book Title>'s <element> stayed with me long after I finished the
work.
The author creates a(n) <element> that is truly memorable.
I was immediately drawn in by the <element>.
I was completely immersed in the <element>.
I love this book's <element>.
The <element> is very compelling.

TABLE 4
Natural language sentences based on an element and descriptor

I'm impressed by this book's <descriptor> <element>.
The author creates a <descriptor> <element> that really stands out.
The <descriptor> <element> is notable.
<Book Title>'s <descriptor> <element> held me captive.
This book's <descriptor> <element> transported me to another time and
place.
The <descriptor> <element> captivated my imagination.
The <Book Title>'s <descriptor> <element> stayed with me long after I
finished the book.
The author creates a <descriptor> <element>.
I was immediately drawn in by the <descriptor> <element>.
I was completely immersed in the <descriptor> <element>.
I am struck by the <descriptor> <element> mystery.
I love this book's <descriptor> <element>.
The <descriptor> <element> is very compelling.

After generation of a natural language recommendation, the recommendation may be transmitted to a receiving user at a user computing device 102 of that user. Thereafter, the user may view the recommendation, and potentially acquire the item. In addition, a receiving user may be enabled to provide feedback to the catalog server 122. In one instance, feedback may include whether the receiving user enjoyed or otherwise has a preference for the recommended item. In another instance, feedback may include specification of one or more of the receiving user's preferences related to elements of the item (e.g., as selected by the user in accordance with aspects of this disclosure). As will be described in more detail below, the catalog server 122 may be configured to analyze feedback of a user, and store such feedback and analysis for further use. In one instance, the catalog server 122 may analyze a user's feedback to rate a recommendation. For example, the catalog server 122 may determine a correlation rate between preferences specified within a recommendation and preferences specified by a receiving user. Where a recommendation includes a recommender-selected element and description, and a receiving user's feedback includes the same element and description, the recommendation may be rated highly (e.g., for successfully identifying elements of the item desirable to a receiving user).

In some embodiments, the catalog server 122 may be configured to automatically generate recommendations for users based on preferences specified by a user, as well as based on preferences associated with items by other users. Illustratively, the catalog server 122 may periodically inspect a user's account data (e.g., as stored within the user account data store 128) to determine general preferences of a user (e.g., specific elements or element-descriptor pairs that have been indicated to be preferred by a user). Thereafter, the catalog server 122 may search the item data store 124 to locate items not yet tracked or consumed by the user and that have elements preferred by the user. For example, where a user has previously indicated a preference for items with an “engaging plot,” the catalog server 122 can inspect the item data store 124 to locate items with an “engaging plot” (as indicated by preferences of other users), and provide a recommendation for the located items to the user. Accordingly, the formation of element-descriptor pair preferences of a user may be utilized to automatically generate recommendations to users.

In some embodiments, the item cataloging service 120 may enable information regarding user's preferences to be shared between users. For example, two users may agree to disclose preferences related to items. In other embodiments, the item cataloging service 120 may provide user preference information (e.g., in anonymized form) either privately or publicly. For example, the item cataloging service 120 may provide aggregate data regarding an item either on a display page regarding the item (e.g., so that other users may review aggregate preferences regarding the item) or directly to a publisher, author, or other authorized entity. In this manner, creators of items may be enabled to receive user feedback regarding an item at a very high level of detail.

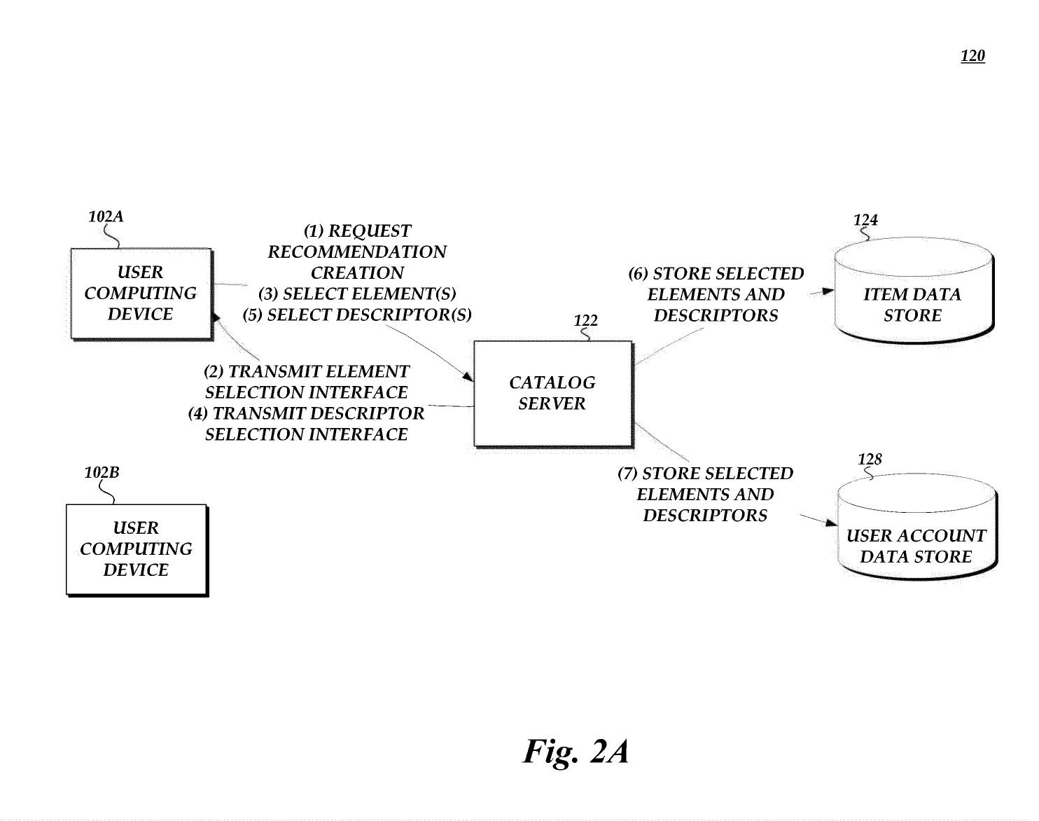

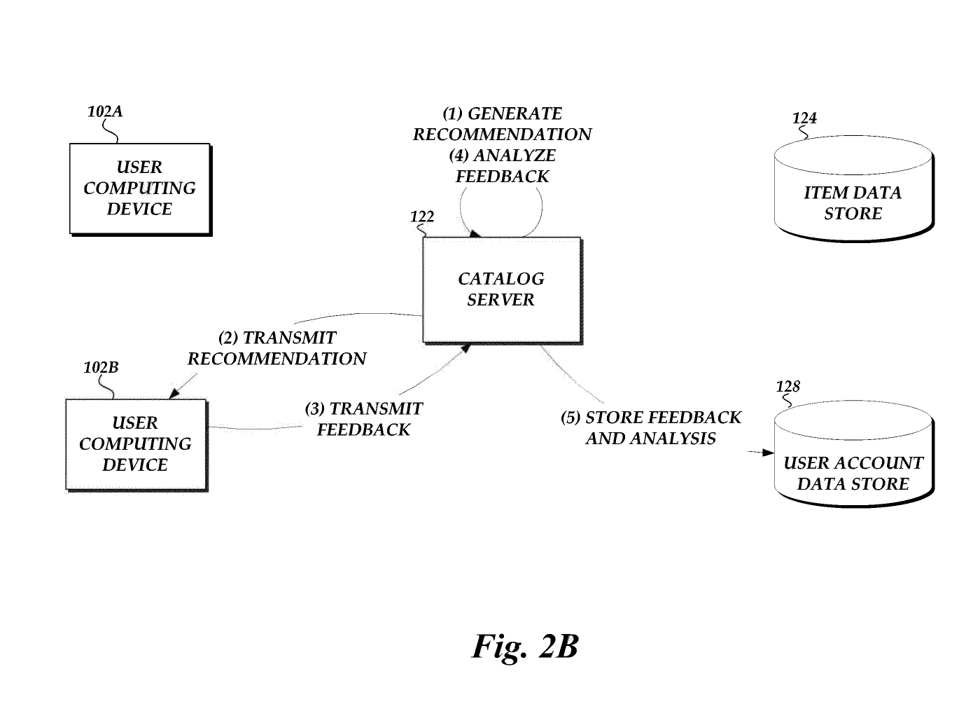

With reference to FIG. 2A, an illustrative interaction for determining a user's preferences for elements of an item will now be described. The interactions of FIG. 2A may begin, for example, after a user utilizing the user computing device 102A has registered or otherwise become associated with the item cataloging service 120, and has indicated an interest in at least one item (e.g., a book). Illustratively, the user's interest in the item may be indicated based on a search by the user for the item (e.g., by input of an item title, author, barcode, book number [e.g., ISBN], etc.).

Thereafter, at (1) the user may request generation of a recommendation for the item. For example, the user of user computing device 102A may desire to transmit a recommendation to a user of user computing device 102B (who may or may not have previously been associated with the item cataloging service 120). As discussed above, such a recommendation may be based on desirable characteristics of elements of the item in question (e.g., a “thrilling plot,” “interesting characters,” etc.). In one embodiment, a recommendation may be based on characteristics of elements that the recommending user (e.g., the user of user computing device 102A) finds desirable. In another embodiment, a recommendation may be based on characteristics of elements that the recommending user believes a receiving user (e.g., the user of user computing device 102B) will find desirable. Illustratively, the recommending user may also make a specification regarding the basis of a recommendation at (1).

Thereafter, at (2), the catalog server 122 provides the user computing device 102A with a selection of elements. As described above, elements generally correspond to individual portions or aspects of a book, and may generally be distinguished from descriptions of an item as a whole (e.g., genre, etc.). For example, elements may include specific portions of an item (e.g., “beginning,” “middle,” “ending”, etc.), or specific aspects (e.g., “conflict,” “dialogue,” “plot,” etc.). In one embodiment, the catalog server 122 may transmit information corresponding to a selectable list of elements. This list may be presented, for example, within a user interface on the user computing device 102A. One illustrative example of such a user interface will be described below with reference to FIG. 3A.

At (3), the user may select at least one element (e.g., from within a presented user interface). Thereafter, at (4), the catalog server 122 may transmit to the user computing device 102A a selection of descriptors corresponding to the selected element. As noted above, descriptors generally act to describe a selected element, rather than an item as whole. In one instance, descriptors correspond to adjectives (e.g., “thrilling,” “complicated,” “alien,” etc.). The list of descriptors may be presented within a user interface on the user computing device 102A, such as the illustrative user interface described below with reference to FIG. 3B.

At (5), the user can select one or more descriptors corresponding to the previously selected elements. Accordingly, a user may specify element and descriptor pairs that indicate their preferences for an item. In one embodiment, users may be enabled to select zero descriptors, and to generate a recommendation based solely on elements. In another embodiment, a user may be enabled to select multiple element and descriptor pairs to specify preferences for an item. In these embodiments, interactions (2) through (5) may therefore be repeated to select multiple element-descriptor pairs.

After a user has selected all desired element-descriptor pairs, the catalog server 122 stores the selected pairs in the item data store 124 and the user account data store 128, at interactions (6) and (7), respectively. Illustratively, storage of the selected element-descriptor pairs into the item data store 124 may enable the item cataloging service 120 to further categorize or classify the item in question. For example, where multiple users have indicated a preference for an item based on a specific element-descriptor pair, the item cataloging service 120 may indicate to additional users that the item is associated with the specific element-descriptor pair (e.g., within a display page related to the item). In this manner, users may be able to gain additional information regarding an item that is not typically provided by traditional sources, such as publishers, distributors or reviews (either professional or user-generated). In addition, storage of the selected element-descriptor pairs into the user account data store 128 enables users to view and track their preference history, and further enables the item cataloging service 120 to generate recommendations to users based on such a preference history. For example, where a user has a preference for a specific element-descriptor pairs, the item cataloging service 120 can review the item data store 124 to locate additional items associated with that element-descriptor pair (e.g., by other users of the item cataloging service 120). Thereafter, the item cataloging service 120 can generate a recommendation to the user for the located items.

The interactions of FIG. 2A described above are intended to be illustrative in nature, and many alterations or permutations of the interactions are contemplated and within the scope of this disclosure. For example, in one embodiment, a user computing device 102A may be provided with a listing of all elements and descriptors at a single point in time (e.g., on installing an application associated with the item cataloging service 120, on requesting creation of a recommendation, etc.). Accordingly, user selection of element-descriptor pairs may require fewer or different interactions with the catalog server 122 (e.g., a single interaction reflecting user selection of a number of element-descriptor pairs). In another embodiment, user selection of element-descriptor pairs may occur separately from a request to generate a recommendation for an item. For example, a user may be enabled to input preferences for an item based on element-descriptor pairs upon selection of an item (e.g., after locating the item on the item cataloging service 120, or after “tracking” the item). Thereafter, a user may be enabled to utilize a previously selected element-descriptor pair during generation of a recommendation. Further, storage of selected element-descriptor pairs may occur differently than as described above. For example, the catalog server 122 may store all selected element-descriptor pairs within a single data store. One skilled in the art will appreciate that other modifications of the interactions described herein are possible.

With reference to FIG. 2B, illustrative interactions for generating a recommendation based on a previously selected element-descriptor pair will be described. Illustratively, the interactions of FIG. 2B may occur subsequent to those of FIG. 2A, after selection of one or more element-descriptor pairs by a user, and receipt of a request to generate a recommendation based on those element-descriptor pairs. Specifically, the interactions of FIG. 2B begin at (1), where the catalog server 122 generates a recommendation based on the previously selected element-descriptor pairs. In one embodiment, the generated recommendation may be in a natural language form. For example, where elements correspond to nouns related to an item, and descriptors correspond to adjectives describing such nouns, the catalog server 122 may utilize a series of templates to generate natural language sentences based on these nouns and adjectives. Examples of such templates are provided above within tables 3 and 4, above. In some instances, templates may be associated with a specific element or element-descriptor pair. In other instances, templates may be associated with multiple elements or element-descriptor pairs. Accordingly, the catalog server 122 may select an appropriate template based on a user selected element-descriptor pair, and utilize the template to generate a natural language recommendation. In one embodiment, where multiple element-descriptor pairs have been selected by a user, multiple natural language recommendations may be generated by the catalog server 122.

Thereafter, at (2), the recommendation is transmitted to the receiving user at the user computing device 102B. Illustratively, the recommendation may be transmitted to the user computing device 102B via electronic mail message (e-mail) or other electronic notification, via an application on the user computing device 102B (e.g., a mobile app), or via hypertext (e.g., HTTP).

After receiving and reviewing the recommendation, the receiving user may be enabled to provide feedback regarding the recommendation. In some instances, a receiving user may desire to provide feedback immediate (e.g., if the user is already aware of the recommended item). In other instances, a receiving user may wish to provide feedback after a period of time (e.g., after acquiring or consuming the recommended item). In some instances, the recommendation may include information to facilitate user acquisition or consumption of a recommended item (e.g., by including a link to acquire the item).

In one embodiment, user feedback regarding a recommendation may include a rating of the recommendation (e.g., on a predetermined scale) and/or commentary of the receiving user on the recommendation. In other embodiments, user feedback regarding a recommendation may include a rating of the element-descriptor pairs used to generate a recommendation (e.g., selection of one or more accurate element descriptor pairs from a set of pairs used to generate the recommendation). In still more embodiments, user feedback may include selection of preferences for the item by the receiving user. For example, a receiving user may be enabled to select a set of elements or element-descriptor pairs describing their preferences for a recommended item (e.g., as described above with respect to FIG. 2A).

After receiving feedback, the catalog server 122 may analyze the feedback at (4). In one embodiment, analysis of feedback may include determining a rating of the transmitted recommendation. Recommendation ratings may be based, for example, on the rating provided to a recommendation by the receiving user. As a further example, recommendation ratings may be based on a comparison between element-descriptor pairs included within the recommendation and element-descriptor pairs selected by a receiving user. For example, where a receiving user has indicated a preference for an item based on the same element-descriptor pairs included within a recommendation, the recommendation may be rated highly by the catalog server 122. Conversely, where a user has indicated a preference for an item based on different element-descriptor pairs than those included within a recommendation, the recommendation may be rated less highly by the catalog server 122. After analyzing the received feedback, the feedback and analysis (e.g., including a receiving user's preferences regarding an item and/or a rating of the recommendation) may be stored within the user account data store 128 at (5).

The interactions of FIG. 2A are intended to be illustrative in nature, and may include alternative or additional interactions. For example, though not shown in FIG. 2B, the catalog server 122 may be configured to notify a user computing device 102A regarding aspects of a recommendation, including transmission of the recommendation to the user computing device 102B, rating of the recommendation by the receiving user, and/or analysis of the recommendation by the catalog server 122. In addition, where a receiving user specifies preferences for a recommended item (e.g., via element-descriptor pairs), those preferences may additionally be stored within the item data store 124 (e.g., in conjunction with additional information regarding the item). As described above, such preferences may thereafter be utilized in the generation of automatic recommendations to users.

With reference to FIG. 3A, an illustrative user interface 300 enabling user selection of elements of an item cataloged by the item cataloging service 120 of FIG. 1 will be described. Specifically, the user interface 300 is output for display to a user by a user computing device 102. In the illustrative example of FIG. 3A, the user computing device 102 is a mobile telephone device. Illustratively, the user interface 300 may be displayed on the user computing device 102 subsequent to receiving a request from a user to generate a recommendation for an item. Accordingly, information regarding the item is displayed within display portion 302. As shown in FIG. 5A, the user interface 300 enables selection of user-preferred elements for the fictitious novel “A Fantastic Journey,” by author “Peter A. Author.” Specifically, display portion 304 includes multiple selectable elements within a tiled list format (e.g., “Characters,” “Chronology,” “Conflict,” etc.). Though not shown within FIG. 3A, the user interface 300 may enable user interaction to modify the displayed information. For example, a user may be enabled to scroll the user interface 300 by dragging a finger vertically on the user interface 300 (e.g., to show additional elements). Further, a user may be enabled to select one or more elements by touching the element on the user interface 300. In one embodiment, selection of a single element immediately transfers the user to a second user interface enabling selection of descriptors for the element. In another embodiment, a user may be enabled to select multiple elements prior to selection of descriptors for those elements. Thereafter, the user may utilize an input (not shown in FIG. 3A) to display a second user interface enabling selection of descriptors for the elements.

One example of such a user interface for selection of descriptors is shown in FIG. 3B. Similarly to FIG. 3A, the user interface 310 of FIG. 3B is output by a user computing device 102 corresponding to a mobile telephone device. Specifically, the user interface 310 enables a user to input descriptors for the element “characters” (represented by the icon 312). Available descriptors for this element are shown within a tiled list format in display portion 314 (e.g., the characters are “alien,” “amoral,” “audacious,” etc.). Accordingly, a user may be enabled to select one or more descriptors by touching the user interface 310. In this manner, a user creates an element-descriptor pair that describes the user's preference for the item. While this disclosure generally refers to element-descriptor pairs, the user interface 310 may further enable selection of multiple descriptors for a single element, thereby creating a one-to-many relationship between the element and descriptors. For ease of language, these relationships are also generally referred to herein as element-descriptor pairs. After selection of desired descriptors, the user may utilize input portion 316 to transmit the selected element-descriptor pairs to the item cataloging service 120. Illustratively, the user may thereafter provide any additional information to be placed within a recommendation (e.g., a personal note or other comments), and the recommendation may be transmitted to a receiving user, as described above with respect to FIG. 2B.

All of the methods and processes described above may be embodied in, and fully automated via, software code modules executed by one or more general purpose computers or processors. The code modules may be stored in any type of non-transitory computer-readable medium or other computer storage device. Some or all of the methods may alternatively be embodied in specialized computer hardware.

Conditional language such as, among others, “can,” “could,” “might” or “may,” unless specifically stated otherwise, are otherwise understood within the context as used in general to present that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y or Z,” unless specifically stated otherwise, is otherwise understood with the context as used in general to present that an item, term, etc., may be either X, Y or Z, or any combination thereof (e.g., X, Y and/or Z). Thus, such disjunctive language is not generally intended to, and should not, imply that certain embodiments require at least one of X, at least one of Y or at least one of Z to each be present.

Unless otherwise explicitly stated, articles such as ‘a’ or ‘an’ should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Any routine descriptions, elements or blocks in the flow diagrams described herein and/or depicted in the attached figures should be understood as potentially representing modules, segments, or portions of code which include one or more executable instructions for implementing specific logical functions or elements in the routine. Alternate implementations are included within the scope of the embodiments described herein in which elements or functions may be deleted, or executed out of order from that shown or discussed, including substantially synchronously or in reverse order, depending on the functionality involved as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A method of generating recommendations for a written work, the method comprising:
transmitting a list of elements of the written work to a user at a user computing device, wherein each element of the list of elements describes a defined portion of the written work;
receiving, from the user computing device, a selection of a first element from the list of elements;
transmitting a list of descriptors of the element to the user computing device, wherein each descriptor of the list of descriptors describes the first element;
receiving, from the user computing device, a selection of a first descriptor from the list of descriptors;
utilizing the first element and the first descriptor to generate a natural-language recommendation for the written work; and
transmitting the natural-language recommendation to an additional entity specified by the user.

2. The computer-implemented method of claim 1, wherein the user computing device is at least one of a laptop computer, a tablet computer, a personal computer, a personal digital assistant (PDA), or a mobile phone.

3. The computer-implemented method of claim 1, wherein each element is a noun.

4. The computer-implemented method of claim 1, wherein each descriptor is an adjective.

5. The computer-implemented method of claim 1 further comprising associating the written work with an element-descriptor pair corresponding to the selected first element and the selected first descriptor.

6. The computer-implemented method of claim 5 further comprising transmitting a set of element-descriptor pairs associated with the written work to a publisher of the written work.

7. The computer-implemented method of claim 1 further comprising associating the user with an element-descriptor pair corresponding to the selected first element and the selected first descriptor.

8. The computer-implemented method of claim 7 further comprising:
selecting an additional written work based at least in part on a set of element-descriptor pairs associated with the written work and the element-descriptor pair associated with the user; and
transmitting to the user a recommendation for the selected additional written work.

9. The computer-implemented method of claim 1, wherein the user computing device is configured to output the list of elements within a pictorial grid.

10. A system to generate recommendations for an item, the system comprising:
a data store including information regarding the item; and
one or more processors configured with computer-executable instructions to:
transmit a set of elements to a user, wherein each element of the set of elements describes a defined aspect of the item;
receive a user selection of a first element from the set of elements;
transmit a set of descriptors to the user, wherein each descriptor of the set of descriptors describes the first element;
receive a user selection of a first descriptor from the list of descriptors;
generate, based at least in part on the first element and the first descriptor, a natural-language recommendation for the item; and
transmit the natural-language recommendation to at least one additional entity specified by the user.

11. The system of claim 9, wherein the item corresponds to at least one of a book, a movie, music content, a tangible product, an intangible product, or a service.

12. The system of claim 9, wherein the one or more processors are further configured to associate the user with an element-descriptor pair corresponding to the selected first element and the selected first descriptor.

13. The system of claim 10, wherein the one or more processors are further configured to:
select an additional item based at least in part on a set of element-descriptor pairs associated with the item and the element-descriptor pair associated with the user; and
transmit to the user a recommendation for the selected additional item.

14. The system of claim 11, wherein the additional item is selected based at least in part on a determination that the element-descriptor pair associated with the user is included within the set of element-descriptor pairs associated with the item.

15. The system of claim 9, wherein the one or more processors are further configured to receive feedback from the additional entity.

16. The system of claim 13, wherein the feedback includes an element-descriptor pair selected by the additional entity.

17. A computer-readable non-transitory storage medium including computer-executable instructions, the computer-executable instructions comprising:
first computer-executable instructions that, when executed by a processor, cause the processor to:
transmit a set of elements to a user, wherein each element of the set of elements describes a defined aspect of an item;
receive a user selection of a first element from the set of elements;
transmit a set of descriptors to the user, wherein each descriptor of the set of descriptors describes the first element; and
receive a user selection of a first descriptor from the list of descriptors; and
second computer-executable instructions that, when executed by the processor, cause the processor to:
generate, based at least in part on the first element and the first descriptor, a natural-language recommendation for the item; and
transmit the natural-language recommendation to at least one additional entity specified by the user.

18. The computer-readable non-transitory storage medium of claim 17, wherein the natural language recommendation is generated based at least in part on a sentence template.

19. The computer-readable non-transitory storage medium of claim 17, wherein the second computer-executable instructions further cause the processor to receive, from the user, a selection of a second descriptor from the list of descriptors, and wherein the natural language recommendation is generated based at least in part on the second descriptor.

20. The computer-readable non-transitory storage medium of claim 17, wherein the user computing device is a mobile telephone.

21. The computer-readable non-transitory storage medium of claim 17, wherein the one or more processors are further configured to receive feedback from the additional entity.

22. The computer-readable non-transitory storage medium of claim 21, wherein the second computer-executable instructions further cause the processor to associate a rating with the user based at least in part on the feedback.

23. The computer-readable non-transitory storage medium of claim 21, wherein the feedback includes an element-descriptor pair selected by the additional entity.

24. The computer-readable non-transitory storage medium of claim 23, wherein the second computer-executable instructions further cause the processor to:
compare the element-descriptor pair selected by the additional entity with the element and descriptor selected by the user; and
associate a rating with the user based at least in part on the comparison.

25. The computer-readable non-transitory storage medium of claim 17, wherein the set of descriptors is determined based at least in part on the selected first element.

26. The computer-readable non-transitory storage medium of claim 17, wherein each element within the set of elements includes a pictorial representation of the element.
